(19) United States
(12) Patent Application Publication
(10) Pub. No.: US 2025/0103141 A1
(43) Pub. Date: Mar. 27, 2025

(54) Electronic System for Controlling Memo Object in Virtual Space and Operating Method Thereof

(71) Applicant: Korea Advanced Institute of Science and Technology, Daejeon (KR)

(72) Inventors: Seok Hyung BAE, Daejeon (KR); Joon Hyub LEE, Daejeon (KR); Dong Hyeok MA, Daejeon (KR); Hae Na CHO, Daejeon (KR)

(21) Appl. No.: 18/285,690

(22) PCT Filed: Apr. 4, 2022
(86) PCT No.: PCT/KR2022/005041

§ 371 Date: Oct. 5, 2023

(30) Foreign Application Priority Data
Apr. 7, 2021 (KR) 10-2021-0045103
Apr. 4, 2022 (KR) 10-2022-0041819

(51) Int. Cl. G06F 3/01; G06T 11/00

(52) U.S. Cl. CPC G06F 3/017; G06F 3/011; G06T 11/00

(57) ABSTRACT

Disclosed are an electronic system for controlling a memo object in a virtual space and an operating method thereof. The disclosed electronic system comprises: an electronic device, which detects, on the basis of an input from a user, the motion of writing on a reference object in a virtual space; and a display device, which displays a scene in the virtual space corresponding to the viewpoint of the user and provides the scene to the user and, in response to the case where the reference object is included in the scene, displays on the reference object the writing corresponding to the writing motion, on the basis of information transmitted from the electronic device, wherein the reference object in the virtual space is disposed on the surface of the electronic device, at least one of the two hands of the user is tracked and displayed in the virtual space, and the tracked hand of the user controls one or more objects in the virtual space.

### TECHNICAL FIELD

The following description relates to an electronic system for controlling a memo object in a virtual space and an operating method thereof.

### BACKGROUND ART

A detachable memo pad with adhesive, which is provided in a suitable size to contain a small amount of information, may be easily attached to various forms of surface and may be easily detached and reattached several times without leaving any traces. This characteristic may allow the memo pad to be widely established as a daily and office supply that is useful for quickly writing down ideas that suddenly come to mind, emphasizing important content in documents, or reminding oneself of what needs to be done.

The memo pad is also an effective problem-solving tool. When people gather in front of a large wall and hold a meeting using such memo pads, the memo pads may allow the people to collect a great amount of information and ideas in a short time, effectively organize them, visualize the complex relationships within them, and thereby efficiently decide concrete solutions. However, such physical memo pads may have the following problems.

First, because the size of a surface onto which a memo pad is to be attached is limited, an applicable memo pad may also be inevitably limited, and a new space may thus be required in the end, which may hinder the smooth conduction of a meeting.

In addition, rearranging memo pads may be a labor-intensive task. Thus, changing the arrangement or sorting order of previous memo pads or arranging a new memo pad between previous memo pads may require great labor to detach and attach many memo pads one by one. However, as the number of memo pads to be detached and attached increases, the task may become more difficult, which may make newly organizing ideas a reluctant task.

Lastly, documenting or storing the results of organizing ideas using physical memo pads may be difficult. This is because, transforming the results into digital diagrams before sharing them may require a great amount of time and effort, and some important memo pads may be omitted or lost in the middle of this process.

These problems may be unavoidable when using physical memo pads.

### DISCLOSURE OF INVENTION

### Technical Goals

The present disclosure provides a memo object control-based electronic system using virtual reality (VR) and its operating method to effectively solve various problems that inevitably occur when using physical memo pads.

The present disclosure provides a memo object control-based electronic system and its operating method that overcome the foregoing problems while having the characteristics of a physical memo pad as an effective problem-solving tool.

The present disclosure may be provided to effectively compensate for the disadvantages of using physical memo pads while maintaining the advantages of solving various problems that may occur when arranging, organizing, and connecting many memo pads to assist with a complicated thought process.

However, technical goals and aspects obtainable from the present disclosure are not limited to the foregoing, and there may also be other goals and technical aspects that are not described above.

### Technical Solutions

According to an embodiment of the present disclosure, there is provided an electronic system including: an electronic device configured to detect a writing motion of writing on a reference object in a virtual space according to an input from a user; and a display device configured to display a scene in the virtual space corresponding to a viewpoint of the user and provide the displayed scene to the user, and in response to the reference object being included in the scene, display handwriting obtained from the writing motion on the reference object based on information transmitted from the electronic device, wherein, in the virtual space, the reference object may be arranged on a surface of the electronic device, at least one of both bands of the user may be tracked to be displayed in the virtual space, and one or more objects present in the virtual space may be controlled by the tracked hand of the user.

Each of the one or more objects present in the virtual space may be controlled by the tracked hand of the user while the handwriting is being maintained.

When the user performs, with the tracked hand, a motion of holding a target object among the one or more objects arranged in the virtual space, moving the target object, and then releasing the target object, the target object may be moved in the virtual space according to the motion of moving and may be arranged at a position in the virtual space corresponding to a position at which the motion of releasing is performed.

When the user performs, with the tracked hand, a motion of crumpling a target object among the one or more objects arranged in the virtual space and then releasing the target object, the target object may be crumpled in the virtual space according to the motion of crumpling and may fall onto a floor in the virtual space according to the motion of releasing.

When the user performs, with the tracked hand, a motion of unfolding a crumpled target object in the virtual space, the target object may be unfolded in the virtual space according to the motion of unfolding and handwriting written on the target object may be displayed.

When the user performs, with both tracked hands, a motion of clenching a first within a predetermined distance, or a motion of clenching a first within the predetermined distance and then moving the hands away from each other, a plane of a size corresponding to a distance between the hands may be generated in the virtual space. When the user performs, with both tracked hands, a motion of adjusting the distance between the hands while maintaining the tracked hands fisted, the size of the plane generated in the virtual space may be controlled according to the adjusted distance between the hands.

When the user performs, with both tracked hands or one tracked hand, a motion of holding and moving a plane in the virtual space and then releasing the plane, the plane may be moved in the virtual space according to the motion of moving and may then be arranged at a position in the virtual space at which the motion of releasing is performed.

When the user performs, with both tracked hands, a motion of holding a plane in the virtual space and reducing a distance between the hands to a predetermined distance or less, in the absence of an object attached to the plane, the plane may be deleted from the virtual space, and in the presence of an object attached to the plane, the plane may not be reduced to less than a size of an edge of the object attached to the plane.

When the user performs a pinch gesture with one of both tracked hands and then performs a pinch gesture with the other hand, a non-directional link that connects the hands may be generated in the virtual space.

When the user performs a pinch gesture with one of both tracked hands and then performs a pinch gesture while moving the other hand in one direction, a directional link that connects the hands in the virtual space and has an arrow displayed in a portion corresponding to the other hand may be generated.

In a state in which the non-directional link or the directional link is generated, when the user releases the pinch gesture within a predetermined distance, for two target objects arranged in the virtual space, with both tracked hands, the non-directional link or the directional link may connect the two target objects in the virtual space.

When the user performs, with the tracked hand, a motion of holding and pulling a link that connects two target objects arranged in the virtual space by a predetermined distance or greater, the link may be deleted from the virtual space.

When the user performs, with the tracked hand, a motion of holding a tag object in the virtual space, moving the tag object to be within a predetermined distance to a link that connects two target objects, and then releasing the tag object, the tag object may be arranged at a predetermined angle in the link according to the motion of releasing.

When the user performs, with the tracked hand, a motion of holding a target object among a plurality of objects arranged in the virtual space and moving the target object to be within a predetermined distance to another object to align the target object and the other object at a predetermined angle, and then releasing the target object, a plane to which the target object and the other object are to be attached may be generated in the virtual space.

When the user performs, with the tracked hand, a motion of holding a target object in the virtual space and moving the target object to be within a predetermined distance on a plane, a feed forward corresponding to the target object may be displayed on the plane in the virtual space. When the user performs a motion of releasing the target object, the target object may be attached to a position of the feed forward displayed on the plane in the virtual space.

When the user performs, with the tracked hand, a motion of moving a target object in a plane arranged in the virtual space on the plane, the target object may be moved according to the motion performed by the user on the plane in the virtual space.

When the user performs a motion of touching a target object in a plane arranged in the virtual space with one of both tracked hands and moving another object with the other hand while the one hand is touching the target object such that the other object is aligned with the target object on the plane, the other object may be aligned with the target object on the plane in the virtual space.

When the user performs, with the tracked hand, a motion of holding a first plane in the virtual space and allowing the first plane to penetrate through a second plane to which one or more objects are attached in a predetermined direction, an object in an area in the second plane through which the first plane penetrates may be moved from the second plane to the first plane according to the motion performed by the user.

When the user performs, with the tracked hand, a motion of holding a first plane in the virtual space and bringing the first plane to be within a predetermined distance to a second plane to which one or more objects are attached, an object in an area in the second plane corresponding to the first plane may be projected onto the first plane in the virtual space. When the user performs a motion of touching the object projected on the first plane, the object corresponding to the motion of touching may be duplicated on the first plane in the virtual space.

At least one of the objects present in the virtual space may be controlled by one or more of a plurality of users accessing the virtual space.

According to an embodiment of the present disclosure, there is provided an electronic system including: a display device configured to display a scene of a virtual space corresponding to a viewpoint of a user and provide the displayed scene to the user, and display an object included in the scene among objects arranged in the virtual space together with handwriting written on the object; and a sensor configured to track at least one of both hands of the user, wherein at least one of both hands of the user may be tracked by the sensor and may be displayed in the virtual space, and one or more objects present in the virtual space may be controlled by the tracked hand of the user.

According to an embodiment of the present disclosure, there is provided an operating method of an electronic system, the operating method including: detecting a writing motion of writing on a reference object present in a virtual space according to an input transmitted from a user to an electronic device; and in response to the reference object being included in a scene of the virtual space corresponding to a viewpoint of the user, displaying handwriting obtained from the detected writing motion on the reference object and providing the handwriting to the user through a display device, wherein, in the virtual space, the reference object may be arranged on a surface of the electronic device, at least one of both hands of the user may be tracked and displayed in the virtual space, and one or more objects present in the virtual space may be controlled by the tracked hand of the user.

According to an embodiment of the present disclosure, there is provided a processing device including: a processor configured to determine a writing motion of writing on a reference object present in a virtual space according to an input of a user detected through an electronic device, and in response to the reference object being included in a scene of the virtual space corresponding to a viewpoint of the user, display handwriting obtained from the detected writing motion on the reference object and provide the displayed handwriting to the user through a display device, wherein the reference object in the virtual space may be arranged on a surface of the electronic device, at least one of both hands of the user may be tracked and displayed in the virtual space, and one or more objects present in the virtual space may be controlled by the tracked hand of the user.

### Effects of Invention

According to an embodiment, using a gesture very similar to a hand motion performed when using a physical memo, a user may easily and intuitively control a memo object in a virtual space without complicated menu buttons or widgets. The user may easily manage idea results by freely writing down ideas on memo objects, arranging the objects, and moving or duplicating many objects at once, if necessary, without being bound by physical constraints.

According to an embodiment, using various gestures with one hand or both hands that are very similar to real ones may generate, control, and delete a memo object in a virtual space, and using a plane in the virtual space may move, duplicate, or align a plurality of memo objects at once.

### BRIEF DESCRIPTION OF DRAWINGS

FIG. 1 is a diagram illustrating an electronic system according to an embodiment.

FIGS. 2 and 3 are diagrams illustrating a virtual space according to an embodiment.

FIG. 4 is a diagram illustrating motions related to object writing and arrangement according to an embodiment.

FIG. 5 is a diagram illustrating motions related to object deletion and restoration according to an embodiment.

FIG. 6 is a diagram illustrating motions related to manual plane generation, size adjustment, and arrangement according to an embodiment.

FIG. 7 is a diagram illustrating motions related to plane deletion according to an embodiment.

FIGS. 8 and 9 are diagrams illustrating motions related to non-directional link and directional link generation according to an embodiment.

FIG. 10 is a diagram illustrating motions related to link attachment and deletion according to an embodiment.

FIG. 11 is a diagram illustrating motions related to tag attachment according to an embodiment.

FIG. 12 is a diagram illustrating motions related to automatic plane generation and plane snapping according to an embodiment.

FIG. 13 is a diagram illustrating motions related to object alignment on another plane according to an embodiment.

FIGS. 14 and 15 are diagrams illustrating motions related to multiple object movements between planes and duplication according to an embodiment.

FIG. 16 is a diagram illustrating motions related to multiple users according to an embodiment.

FIG. 17 is a flowchart illustrating an operating method of an electronic system according to an embodiment.

### BEST MODE FOR CARRYING OUT INVENTION

The following detailed structural or functional description is provided as an example only, and various alterations and modifications may be made to examples. Here, examples are not construed as limited to the present disclosure and should be understood to include all changes, equivalents, and replacements within the idea and the technical scope of the disclosure.

Although terms, such as, first, second, and the like are used to describe various components, the components are not limited to the terms. These terms should be used only to distinguish one component from another component. For example, a first component may be referred to as a second component, and similarly the second component may also be referred to as the first component.

It should be noted that, if one component is described as “connected,” “coupled,” or “joined” to another component, a third component may be “connected,” “coupled,” and “joined” between the first and second components, although the first component may be directly connected, coupled, or joined to the second component.

The singular forms “a,” “an,” and “the” are intended to include the plural forms as well, unless the context clearly indicates otherwise. It will be further understood that the terms “comprises/comprising” and/or “includes/including,” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art and are not to be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like components and a repeated description related thereto will be omitted.

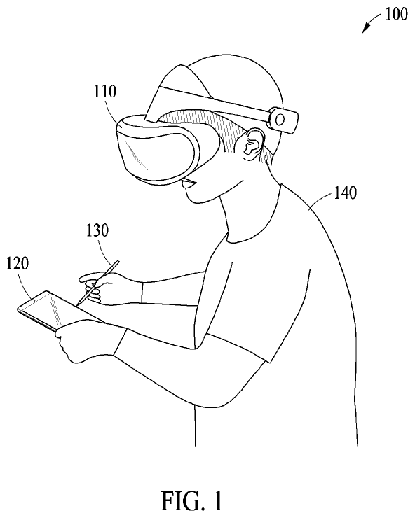

FIG. 1 is a diagram illustrating an electronic system according to an embodiment.

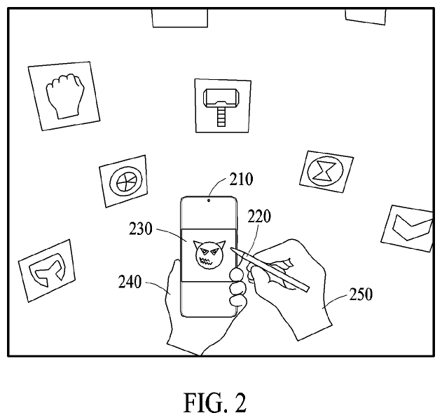

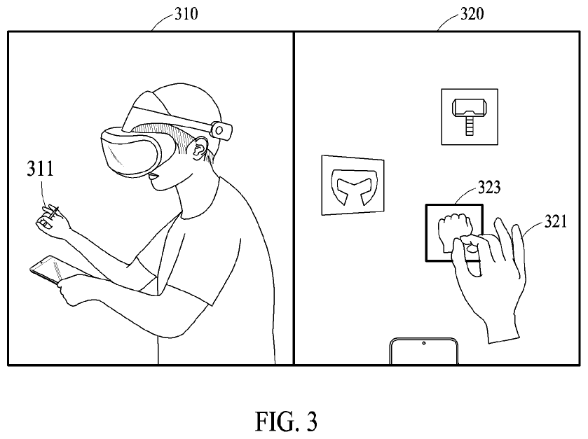

According to an embodiment, an electronic system 100 may generate an object in a three-dimensional (3D) virtual space, write on the object, or control the object, based on a motion (e.g., a hand gesture, a touch input, etc.) and/or a pen input of a user 140. The object, which is a virtual object generated and arranged in the virtual space, may correspond to a physical memo pad described above. The user 140 may write letters, numbers, symbols, drawings, and the like on the object in the virtual space, and control the object in the virtual space while maintaining handwriting written on the object. The virtual space will be described in detail below with reference to FIGS. 2 and 3.

The electronic system 100 may include a display device 110 and an electronic device 120. The electronic system 100 may further include at least one of a sensor (not shown) configured to track at least one of both hands of the user 140 or a sensor (not shown) configured to detect a direction and/or position of a gaze of the user 140.

The display device 110 may be a device configured to display a scene of the virtual space corresponding to a viewpoint of the user 140 and provide the displayed scene to the user 140. The display device 110 may be worn by the user 140 but is not limited to the example described above or shown in FIG. 1, and any device of any shape or type that may display a scene of the virtual space corresponding to a viewpoint of the user 140 and provide it to the user 140 may be employed. For example, in a case in which the display device 110 is a head-mounted display (HMD) worn on the head of the user 140, the display device 110 may use one or more sensors for detecting a direction of a viewpoint of the user 140 to determine the scene of the virtual space to be provided to the user 140. Alternatively, a separate processing device (e.g., a server, etc.) (not shown) may generate a scene of the virtual space that is based on a direction and/or position of a viewpoint of the user 140 using one or more sensors for detecting the direction and/or position of the viewpoint of the user 140, and the display device 110 may receive the generated scene and provide it to the user 140.

The electronic device 120, which is a device for the user 140 to write on the object in the virtual space, may have a shape (e.g., a flat surface and the like) that may assist the user 140 in writing. The electronic device 120 may include, for example, various computing devices such as a mobile phone, a smartphone, a tablet, an e-book device, and a laptop, but is not limited thereto.

For example, the user 140 may perform a writing motion of writing on the surface of the electronic device 120 using a pen 130. The electronic device 120 may detect an input from the user 140 through the pen 130. For example, when the pen 130 contacts a touchscreen of the electronic device 120 or approaches within a predetermined distance, the electronic device 120 may detect this and determine a handwriting input from the user 140.

For another example, the user 140 may directly write on the touchscreen of the electronic device 120 by hand without using the pen 130. The electronic device 120 may determine the handwriting input from the user 140 by detecting or sensing a touch of the user 140 input to the touchscreen.

The electronic device 120 may transmit the handwriting input of the user 140 directly to the display device 110 or through a separate processing device, and in response to the handwritten object being input to the viewpoint of the user 140, the display device 110 may display the handwriting included in the object together with the object and provide them to the user 140.

A position of the electronic device 120 may be determined based on an embedded sensor (e.g., a depth camera, etc.). Alternatively, the position of the electronic device 120 may be determined based on a separate sensor (not shown). The electronic device 120 may be displayed in the virtual space according to a relative position between the electronic device 120 and the user 140 determined based on the position of the electronic device 120.

As described in detail below, the user 140 may control on an object arranged in the virtual space, using at least one of both hands. For example, the user 140 may perform at least one of motions including arranging an object, deleting the object, restoring the object, aligning the object in a plane, moving and duplicating the object to another plane, manually generating a plane onto which the object is attached and adjusting the size of the plane, arranging the plane, deleting the plane, automatically generating the plane, snapping, generating a link that connects two objects, attaching the link, and deleting the link, which will be described in detail below with reference to the accompanying drawings.

According to an embodiment, the electronic system 100 may further include a processing device connected to the display device 110 and the electronic device 120 wirelessly and/or by wire, and the processing device may receive, from the electronic device 120, a user input and/or motion detected by the electronic device 120 and may determine a scene of the virtual space corresponding to a viewpoint of a user and transmit the determined scene to the display device 110. The display device 110 may then provide the scene received from the processing device to the user. The processing device may determine a motion of writing on a reference object present in the virtual space according to the user input received from the electronic device 120 or may receive motion information associated with the motion of the user determined by the electronic device 120. In addition, in response to the reference object being included in the scene of the virtual space corresponding to the viewpoint of the user, the processing device may perform a process of displaying, on the reference object, handwriting obtained from the writing motion, based on the information received from the electronic device 120 and transmit a result of performing the process to the display device 110 to provide it to the user through the display device 110. The processing device may perform a process of arranging the reference object on the surface of the electronic device 120 in the virtual space, perform a process of displaying at least one of both hands of the user that is being tracked in the virtual space, and perform a process of controlling one or more objects present in the virtual space by the tracked hand of the user. The results obtained by the processing performed by the processing device may be transmitted to the display device 110 and then be provided to the user through the display device 110. The processing device may include one or more processors for performing the processes described above. What is described herein may also apply to the processing device, and thus a more detailed description thereof is omitted here.

FIGS. 2 and 3 are diagrams illustrating a virtual space according to an embodiment.

Referring to FIG. 2, an example scene in which a user writes on a reference object 230 using an electronic device 210 and a pen 220 in a virtual space is shown. For the convenience of description, an object on which a user is writing may be referred to herein as a reference object (e.g., the reference object 230) to distinguish it from a plurality of other objects arranged in the virtual space.

As shown in FIG. 2, the electronic device 210, the pen 220, and both hands 240 and 250 may be displayed in the virtual space. The reference object 230 may be arranged on the electronic device 210, and the hands 240 and 250 may hold the electronic device 210 and the pen 220, respectively. A scene of the virtual space shown in FIG. 2 may correspond to a real situation shown in FIG. 1 (e.g., the user writes on the electronic device 120 with the pen 130). The reference object 230 may be disposed on a portion or entirety of one surface of the electronic device 210, and handwriting made with the pen 220 may be displayed on the reference object 230.

Although an example of holding the electronic device 210 with a left hand 240 and holding the pen 220 with a right hand 250 is shown in FIG. 2, this is provided merely as an example for the convenience of description, and the respective roles of the hands 240 and 250 may change by the user.

Also, one or more objects may be arranged in the virtual space, and objects included in a scene of the virtual space corresponding to a viewpoint of the user may be displayed. The objects may include various types of handwriting made by the user. In addition, some of the objects may include handwriting provided in the form determined by an electronic system. For example, keywords predetermined for specific documents may each be included in an object by the electronic system, or meeting agendas may each be included in an object by the electronic system to assist a related meeting or conference in proceeding smoothly, but examples are not limited thereto.

Although not shown in FIG. 2, some of a plurality of objects arranged in the virtual space may have different sizes, different shapes (e.g., rectangles, triangles, circles, stars, etc.), and/or different colors from those of other objects. For example, an object (e.g., an object including an agenda or a keyword) representing objects arranged in a specific area of the virtual space may be determined to be visually easily recognizable, as it is larger than other objects, has a unique shape, or has a different color.

Referring to FIG. 3, in response to a motion of holding an object with one hand 311 performed by the user in a real space 310, a tracked hand 321 of the user may also hold an object 323 in a virtual space 320. The object 323 held by the user may be displayed (e.g., in a bold frame) visually differently from other objects, and thus intuitive feedback on, for example, what the currently held object 323 is may be provided to the user. Although the one hand 311 is shown as a right hand in FIG. 3, this is provided merely as an example for the convenience of description, and the foregoing description may also apply to a case where the one hand 311 is a left hand.

Motions performed by the user in the real space 310 may be sensed or detected through one or more sensors and immediately reflected in the virtual space 320. Accordingly, writing on a memo object in a virtual space and arranging the written object in the virtual space may enable controlling the memo object with various gestures of both hands similar to ones in reality, free from constraints of a physical space. Various gestures performed to control objects will be described in detail below with reference to the accompanying drawings.

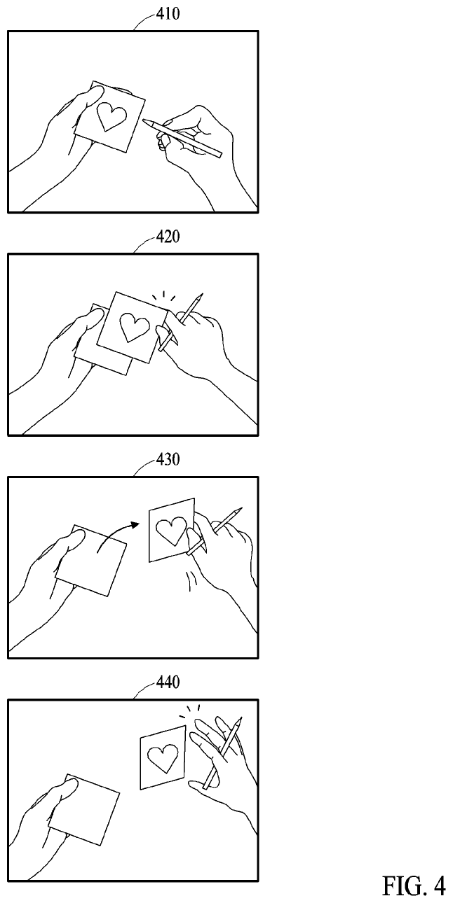

FIG. 4 is a diagram illustrating motions related to object writing and arrangement according to an embodiment.

Steps 410 to 440 to be described with reference to FIG. 4 show a scene in a virtual space in which hands, a pen, and an object are displayed. Here, the hands and the pen may correspond to hands of a user and a pen present in a real space, and may be tracked by one or more sensors in the real space and may then be displayed in the virtual space.

Referring to FIG. 4, an object writing motion will be described through step 410 and an object arrangement motion will be described through steps 420 to 440.

In step 410, the user may hold an object on which the user is to write with a first hand in the virtual space and write on the object using a pen held with a second hand. In the corresponding real space, the user may hold an electronic device with the first hand and write on the electronic device using a pen held with the second hand. The first hand may be a left hand of the user, and the second hand may be a right hand of the user, but examples are not limited thereto. In some cases, the first hand may be the right hand, and the second hand may be the left hand.

Although not displayed in the virtual space in step 410, a position or direction of the electronic device in the real space may be detected and displayed in the virtual space, and the object may be arranged on the surface of the electronic device displayed in the virtual space. The position or direction of the electronic device may be sensed or detected through a separate sensor or a sensor (e.g., a gyro sensor, an acceleration sensor, etc.) included in the electronic device. Writing on the object may be detected based on a touch input provided by the pen to a touchscreen of the electronic device or based on communication (e.g., Bluetooth connection) between the pen and the electronic device. The detected writing or handwriting may be displayed on the object in the virtual space.

In step 420, when the user performs a pinch gesture after bringing their hand closer to be within a predetermined distance to the object in the virtual space, the object may be fixed to the pinch gesture. In addition to such a pinch gesture, a gesture of fixing an object to a hand of a user may be set in various ways by the user or the system. In step 430, when the user moves the hand while maintaining the pinch gesture in the virtual space, the object may move according to such a hand movement. In step 440, when the user releases the pinch gesture after moving the hand to a desired position in the virtual space, the object may be arranged at the corresponding position.

That is, in steps 420 to 440, when the user performs, using a hand being tracked, a motion of holding and moving an object in the virtual space and then releasing the object, the object may be moved in the virtual space according to the moving motion, and arranged at a position in the virtual space corresponding to a position at which the releasing motion is performed. In this case, handwriting written on the object may be maintained as it is. In addition, according to some embodiments, the object held by a pinch gesture in the virtual space may be displayed with its edge in bold or in a different color, and thus which object is held by the pinch gesture, whether an object intended by the user is correctly held by the pinch gesture, or the like may be provided as visual feedback to the user.

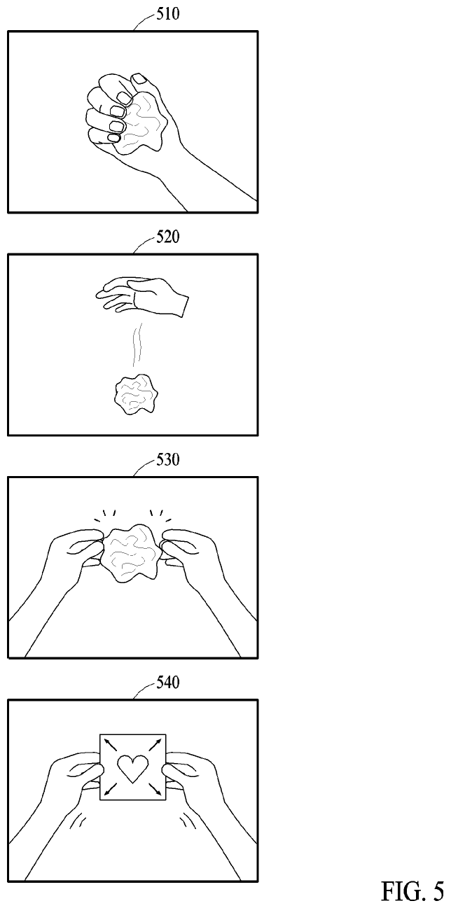

FIG. 5 is a diagram illustrating motions related to object deletion and restoration according to an embodiment.

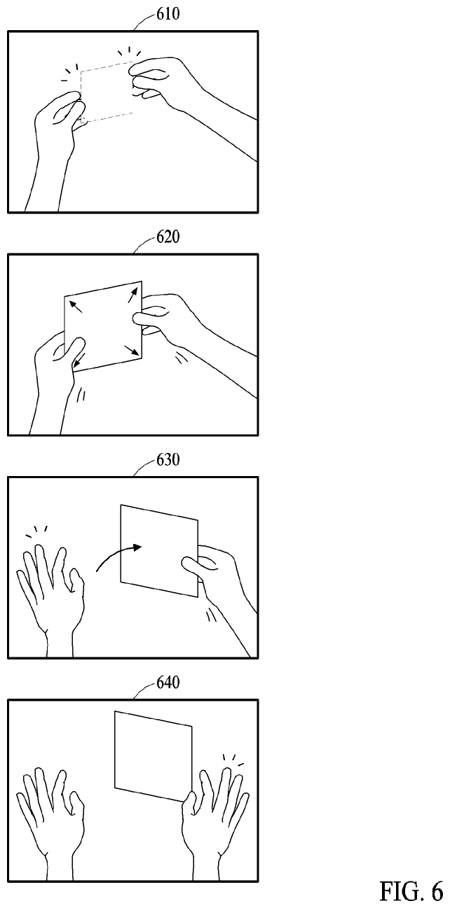

Step 510 to 540 to be described with reference to FIG. 5 show a scene in a virtual space in which hands and an object are displayed. Here, the hands may correspond to hands of a user present in a real space, and may be tracked by one or more sensors in the real space and may then be displayed in the virtual space. This may also apply to what is to be described below with reference to FIGS. 6 to 15, and a more detailed description thereof will be omitted.

Referring to FIG. 5, an object deletion motion will be described through steps 510 and 520, and an object restoration motion will be described through steps 530 and 540.

In step 510, a user may bring their hand to be within a predetermined distance to an object to be deleted among one or more objects arranged in a virtual space. According to some embodiments, the object to which the hand of the user being tracked approaches within the predetermined distance may be displayed visually differently from other objects and may be, for example, displayed with its edge in bold or displayed in a different color. As the object to which the hand of the user approaches within the predetermined distance among one or more objects arranged in the virtual space is displayed visually differently from other objects, the user may intuitively recognize whether an object to be controlled is selected accurately and may thereby accurately control the object according to the intension of the user.

When the user performs a motion of crumpling the object with the hand approaching close to the object in the virtual space, that is, a motion of clenching a fist, visual feedback that the object is crumpled in the virtual space may be provided to the user. As the object is crumpled, handwriting written on the object may no longer be displayed, but examples are not limited thereto.

In step 520, when the user performs a motion of opening the first or a motion of opening the hand holding the object, the object may fall onto the floor in the virtual space, and the object may thus be deleted. In addition to such a visual effect of deleting an object, various visual effects, for example, a visual effect of moving an object into a trash can arranged in the virtual space, may also be applicable without limitation.

In step 530, when the user performs a motion of holding the crumpled object in the virtual space, the object may be fixed to the hand of the user performing the motion of holding the object. For example, the user may hold the crumpled object that has fallen on the floor in the virtual space or may hold the crumpled object in the trash can.

In step 540, when the user performs a motion of unfolding the crumpled object in the virtual space, the object may be unfolded and restored in the virtual space according to such an unfolding motion. For example, the unfolding motion may correspond to a motion performed by the user to move both hands holding the crumpled object in opposite directions, but examples are not limited thereto. The restored object may display again the handwriting.

FIG. 6 is a diagram illustrating motions related to manual plane generation, size adjustment, and arrangement according to an embodiment.

Referring to FIG. 6, manual plane generation and size adjustment motions will be described through steps 610 and 620, and a plane arrangement motion will be described through steps 630 and 640. A plane displayed in a virtual space may correspond to a layer to which one or more objects are attached, and a user may easily control a plurality of objects using the plane.

In step 610, when the user performs a first clenching motion while bringing both hands being tracked to be within a predetermined distance, a plane having a size corresponding to a distance between the hands may be displayed in the virtual space. In this case, for the plane displayed in the virtual space, the plane in a state before generated and a plane in a state after generated may be displayed visually differently. For example, the plane in the state before generated may be more transparent and have edges indicated in broken lines, compared to the plane in the state after generated.

Although a gesture of generating a plane and a gesture of deleting an object described in step 510 of FIG. 5 may be considered similar to each other in that they both use a first clenching motion, there may be the following differences. To delete an object, there requires an object which is a target to be deleted, and a motion of clenching a first with a hand of a user may be performed while the hand of the user approaches close to the object. In contrast, to generate a plane, a motion of clenching a first with both hands of a user may be performed while the hands approach close to each other. Further, according to embodiments, a condition that there is no object near the hands that clench a first may be added to generate a plane, but examples are not limited thereto. Such a difference in condition may effectively and intuitively exclude a probability of confusion between the gesture of generating a plane and the gesture of deleting an object.

In step 620, when the user performs a motion of moving the fisted hands away from each other, the plane may be adjusted to have a size corresponding to a distance between the hands in the virtual space, and when the user performs a motion of releasing the fisted hands, a plane having a size corresponding to the distance between the hands may be generated in the virtual space.

In step 630, when the user performs a motion of holding and moving the plane in the virtual space with one or both hands being tracked, the plane may be moved along the hand being tracked in the virtual space.

In step 640, when the user performs a motion of releasing the hand holding the plane in the virtual space, the plane may be arranged at a position in the virtual space corresponding to a position at which the releasing motion is performed. A direction of the plane arranged in the virtual space may be determined according to a direction of the hand performing the releasing motion, but examples are not limited thereto.

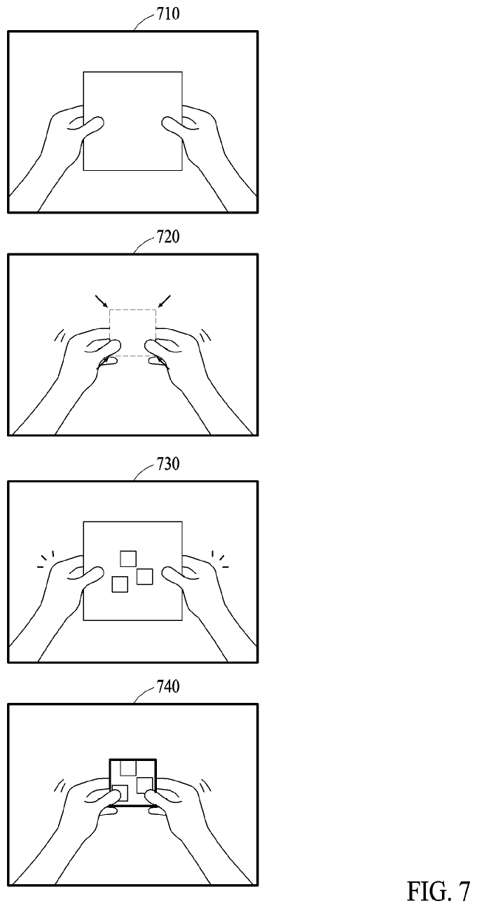

FIG. 7 is a diagram illustrating motions related to plane deletion according to an embodiment.

Referring to FIG. 7, a plane deletion motion will be described through steps 710 to 740.

In step 710, a user may hold a plane arranged in a virtual space using both hands being tracked. In this case, the plane may be one to which no objects are attached. According to some embodiments, the plane held by the hands of the user in the virtual space may be displayed visually differently from other planes, for example, displayed with its edge in bold or displayed in a different color.

In step 720, when the user performs a motion of reducing a distance between the hands holding the plane in the virtual space to a predetermined distance or less, the plane to which no object is attached may be deleted from the virtual space.

In step 730, the user may hold a plane arranged in the virtual space using both hands being tracked. In this case, the plane may be one to which one or more objects are attached. Similarly, according to some embodiments, the plane held by the hands of the user in the virtual space may be displayed visually differently from other planes, for example, displayed with its edge in bold or displayed in a different color.

In step 740, even when the user performs the motion of reducing the distance between the hands holding the plane in the virtual space to the predetermined distance or less, the plane with the attached objects may not be reduced in size more than the size of an edge of the attached objects in the virtual space and may not be deleted either. In this case, when there is only one attached object, the plane may not be reduced to be less than the size of the object, but when there are two or more attached objects, the plane may be reduced to the minimum size that may include all the objects but not be reduced less. This may be to prevent an object from being unintentionally deleted as the plane is deleted.

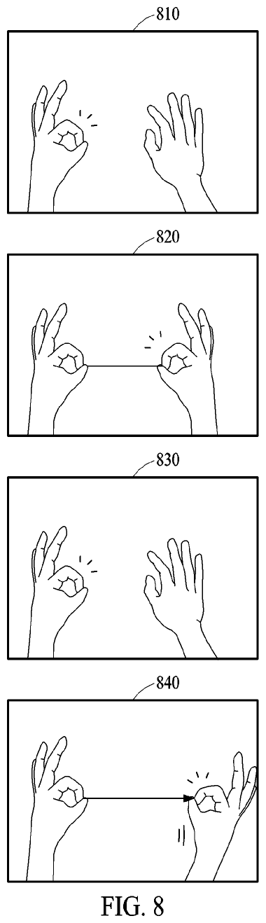

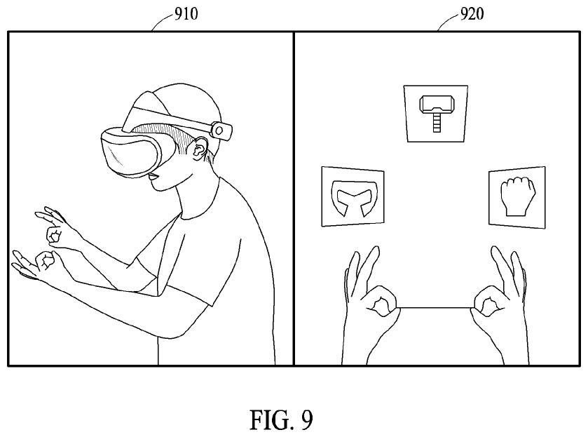

FIGS. 8 and 9 are diagrams illustrating motions related to non-directional link and directional link generation according to an embodiment.

Referring to FIG. 8, a non-directional link generation motion will be described through steps 810 and 820, and a directional link generation motion will be described through steps 830 and 840. Although it is shown in FIG. 8 that a first pinch gesture is performed with a left hand and then a second pinch gesture is performed with a right hand for the convenience of description, examples are not limited thereto, and the following description may also apply to a case in which the first pinch gesture is performed with the right hand and then the second pinch gesture is performed with the left hand.

When a user performs a pinch gesture using one of both hands being tracked in step 810 and then performs a pinch gesture using the other hand in step 820, a non-directional link that connects the hands in virtual space may be generated. The non-directional link may refer to a link that simply connects two points with no specific direction indicated. According to some embodiments, there may be additional conditions related to link generation to detect more accurately the intention of the user. For example, a condition that both hands perform respective pinch gestures within a predetermined distance or a condition that both hands performing respective pinch gestures face each other may be additionally required, but examples are not limited thereto.

When the user performs a pinch gesture using one of both hands being tracked in step 830 and then performs a pinch gesture while moving the other hand in one direction in step 840, a directional link that connects the hands in the virtual space and has an arrow in a portion corresponding to the other hand may be generated. The directional link may refer to a link that connects two points while indicating a specific direction and may include an arrow pointing to a specific direction, that is, a direction that moves when the other hand performs a pinch gesture. According to some embodiments, there may be additional conditions related to directional link generation to detect more accurately the intention of the user. For example, a condition that a moving speed and/or moving distance of the other hand performing the pinch gesture is greater than or equal to a predetermined threshold, a condition that both hands perform respective pinch gestures within a predetermined distance, or a condition that both hands performing the pinch gestures face each other may be additionally required, but examples are not limited thereto.

Referring to FIG. 9, in a case in which a user performs a gesture of generating a non-directional link, a real space 910 and a virtual space 920 are shown. In the real space 910, the user may perform a pinch gesture using both hands raised in the air while wearing a display device, and in a scene of the virtual space 910 to be provided to the user in response to this, a non-directional link may be generated to connect both hands, and objects included in the scene corresponding to a viewpoint of the user may be displayed together therewith.

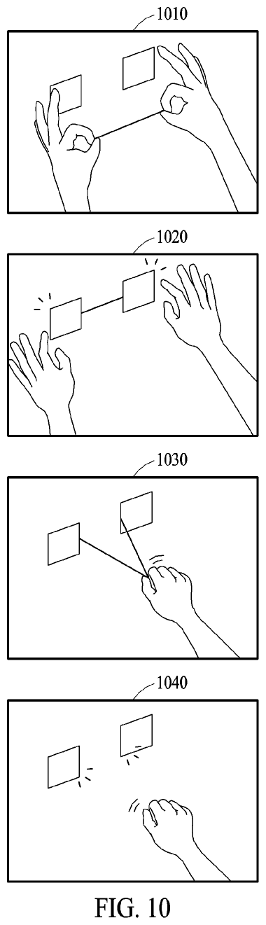

FIG. 10 is a diagram illustrating motions related to link attachment and deletion according to an embodiment.

Referring to FIG. 10, a link attachment motion will be described through steps 1010 and 1020, and a link deletion motion will be described through steps 1030 and 1040. Although a non-directional link is mainly described with reference to FIG. 10 for the convenience of description, examples are not limited thereto, and the following description may also apply to a directional link.

When a link is generated, a user may bring both hands being tracked to be within a predetermined distance between two objects arranged in a virtual space in step 1010, and when the user releases a pinch gesture of the hands in such a state, the link may connect the two objects in virtual space in step 1020. According to some embodiments, when the user brings the hands performing the pinch gesture to be close to objects, an object in the closest proximity may be displayed visually differently (e.g., displayed with its edge in bold and/or displayed in a different color), and which object the link is connected may be intuitively fed back to the user, when the pinch gesture is released.

When the user performs a motion of holding the link connecting the two target objects arranged in the virtual space using a hand being tracked in step 1030 and performs a motion of pulling the link by a predetermined distance or more in step 1040, the link may be deleted from the virtual space.

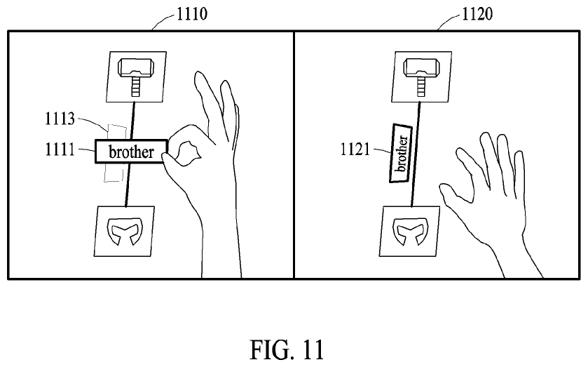

FIG. 11 is a diagram illustrating motions related to tag attachment according to an embodiment.

Referring to FIG. 11, a motion of attaching a tag object to a link connecting two objects will be described through steps 1110 and 1120. Although the following description provided with reference to FIG. 11 may focus on a non-directional link for the convenience of description, the following description may also apply to a directional link.

The tag object, which refers to an object to be attached to a link that connects two objects, may include handwriting that represents a relationship between the two objects. According to some embodiments, the tag object may have a size, shape, and color different from those of a general object described above and may thus assist a user in intuitively recognizing the tag object.

In step 1110, when the user performs a motion of holding a tag object 1111 in a virtual space using both hands being tracked and moving it to be within a predetermined distance to a link connecting two objects, a position 1113 at which the tag object 1111 is to be attached in the virtual space may be visually displayed. The position 1113 may be determined based on the link. For example, the position 1113 may correspond to a middle position of the link and may be determined to be parallel to the link, but examples are not limited thereto.

In step 1120, when the user performs a motion of releasing a tag object 1121 in the virtual space, the tag object 1121 may be attached to the position 1113 displayed in step 1110.

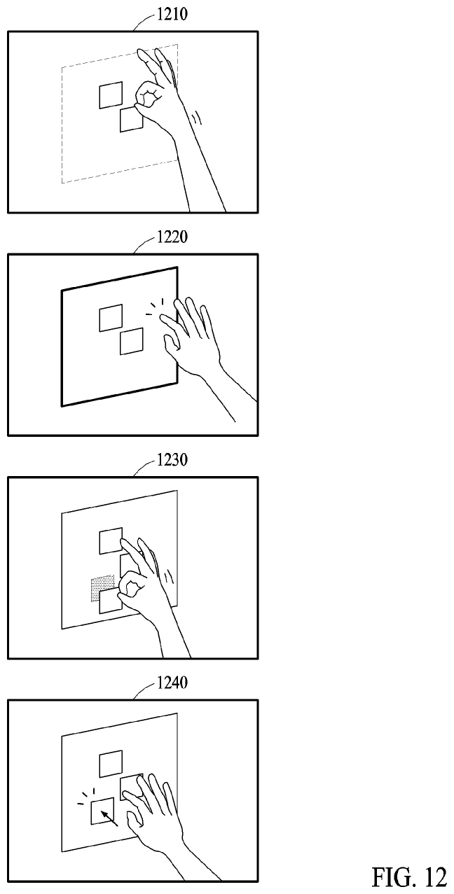

FIG. 12 is a diagram illustrating motions related to automatic plane generation and plane snapping according to an embodiment.

Referring to FIG. 12, an automatic plane generation motion will be described through steps 1210 and 1220, and a plane snapping motion will be described through steps 1230 and 1240.

In step 1210, when a user performs a motion of holding a target object among a plurality of objects arranged in a virtual space using a hand being tracked and moving it to be within a predetermined distance to another object, and the target object and the other object are aligned within a predetermined angle, a plane to which the target object and the other object are to be attached may be visually displayed in the virtual space. In this case, a condition that the target object is aligned within the predetermined angle at a position parallel to the other object may be required.

In step 1220, when the user performs a motion of releasing the target object, the plane to which the target object and the other object are to be attached may be generated in the virtual space, and the target object and the other object may be attached to the generated plane.

In step 1230, when the user performs a motion of holding the object in the virtual space using the hand being tracked and moving it to be within a predetermined distance to the previously generated plane, a feed forward corresponding to the object in the virtual space may be displayed on the plane. The feed forward may indicate a position to which the object is to be attached when the user performs a motion of releasing the object afterward. According to some embodiments, there may be additional conditions related to plane snapping to detect more accurately the intension of the user. For example, the feed forward may be displayed on the plane only when a condition that the object held by the hand of the user is parallel to the plane within a predetermined distance and within a predetermined angle is satisfied. In this case, the predetermined angle that is determined in advance to be parallel to the plane may have a wider range than the predetermined angle required in step 1210. That is, the condition that a target object is parallel to another object to generate a plane may be determined to be a different reference from such a parallel condition required for plane snapping. According to some embodiments, the condition that a target object is parallel to another object for plane generation may be stricter than the parallel condition required for plane snapping, but examples are not limited thereto.

In step 1240, when the user performs a motion of releasing the object, the object may be attached to a position of the feed forward displayed on the plane in the virtual space.

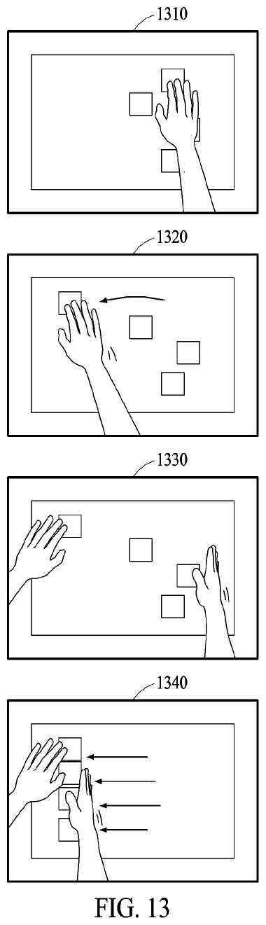

FIG. 13 is a diagram illustrating motions related to object alignment on another plane according to an embodiment.

Referring to FIG. 13, a motion of moving an object in a plane will be described through steps 1310 and 1320, and a motion of aligning an object in a plane will be described through steps 1330 and 1340.

In step 1310, when a user performs a motion of touching an object within a plane disposed in a virtual space using a hand being tracked, the object touched by the user in the virtual space may be displayed visually differently. For example, the touched object may be displayed with its edge in bold or in a different color. In step 1320, when the user performs a motion of moving the touched object on the plane, the object may be moved according to the motion performed by the user on the plane in the virtual space.

In step 1330, when the user touches a target object on a plane disposed in the virtual space using one of both hands being tracked and touches another object to be aligned with the target object on the plane while touching the target object, a guiding line that is based on the target object may be displayed on the plane. The guiding line may be a vertical line or a horizontal line that is based on the target object, and a line that is vertical to a direction in which the other object is to be aligned may be determined as the guiding line from between the vertical line and the horizontal line and may then be displayed on the plane. For example, in a case of moving the other object horizontally and aligning it in a vertical direction with respect to the target object, the vertical line that is based on the target object may be displayed as the guiding line on the plane. Alternatively, in a case of bringing a hand blade with a hand open to be close to the other object to move the other object horizontally, a vertical line parallel to the hand blade or similar to an angle of the hand blade may be displayed based on the target object, and as the hand blade moves horizontally, the other object may also be moved horizontally along with the movement of the hand blade. However, examples are not limited thereto, and in addition to the foregoing examples, various guiding lines for alignment may be displayed on a plane. Although the guiding line is described above as a vertical line or a horizontal line, oblique lines with various angles may also be used as the guiding line in some cases.

In step 1340, when the user performs a motion of moving the other object to be aligned with the target object on the plane, the other object may be aligned with the target object on the plane in the virtual space. In this case, the other object may be one or more objects touched by the user among objects attached to the plane, exclusive of the target object.

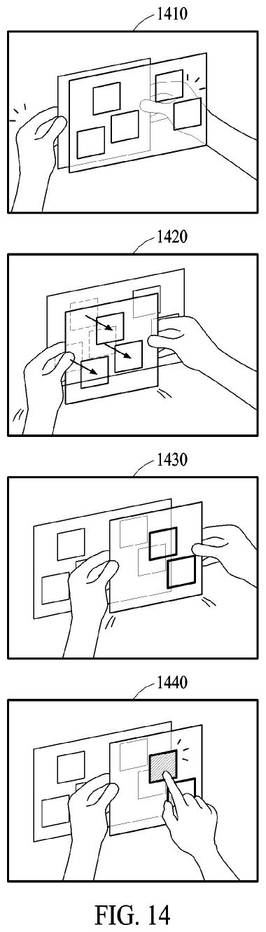

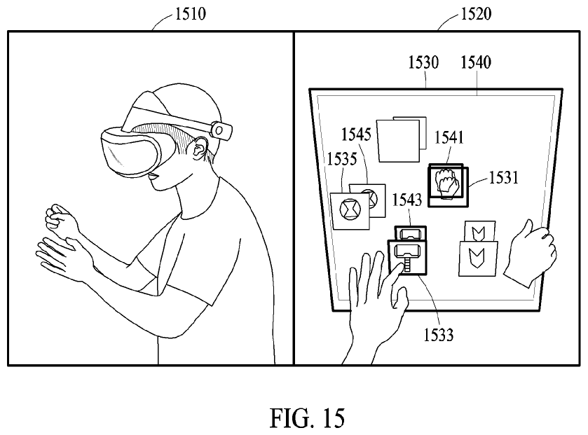

FIGS. 14 and 15 are diagrams illustrating motions related to multiple object movements between planes and duplication according to an embodiment.

Referring to FIG. 14, a motion of moving an object between planes will be described through steps 1410 and 1420, and a motion of duplicating an object between planes will be described through steps 1430 and 1440.

In step 1410, a user may arrange a first plane behind a second plane to which one or more objects are attached in a virtual space, using a hand being tracked. In step 1420, when the user performs a motion of allowing the first plane to penetrate through the second plane in a predetermined direction (e.g., from the back to the front of the second plane) while holding the first plane, an object in an area in the second plane through which the first plane penetrates may be moved from the second plane to the first plane by the motion performed by the user. Such a gesture as if using a sieve may allow a movement of the object from the first plane to the second plane to be intuitively performed. In step 1420, as shown in FIG. 14, the first plane held by the user with both hands penetrates through a left side of the second plane, and thus objects present on the left side of the second plane may be moved to the first plane while objects present on a right side may remain the same on the second plane.

The predetermined direction may be changed variously according to embodiments. For example, in addition to an example of moving the first plane from the back to the front of the second plane, an example of moving the first plane from the front to the back and then to the back may be applied without limitation.

In step 1430, when the user performs a motion of holding the first plane in the virtual space using the hand being tracked and bringing it to be within a predetermined distance to the second plane to which one or more objects are attached, an object in an area in the second plane corresponding to the first plane may be projected onto the first plane. In step 1430, as shown in FIG. 14, the first plane held by the hand of the user may correspond to the right side of the second plane disposed behind the first plane, and thus objects present on the right side of the second plane may be projected onto the first plane while objects present on the left side of the second plane may not be projected onto the first plane. The projection may be performed in various ways and may not be limited to any specific form.

In step 1440, when the user performs a motion of touching an object projected on the first plane, the object corresponding to the touching motion may be duplicated on the first plane in the virtual space.

Referring to FIG. 15, in a case in which a user performs a gesture on objects between planes, a real space 1510 and a virtual space 1520 are shown. In the real space 1510, a user may perform a touching gesture with a left hand, with a right hand being fisted, while raising both hands in the air with a display device worn on them. Corresponding to this, a scene of the virtual space 1520 to be provided to the user may display a first plane 1530 that is held by the right hand and is arranged in front of a second plane 1540 while the left hand is touching an object projected on the first plane 1530.

A first object 1531 of the first plane 1530 may be a projection of a first object 1541 of the second plane 1540 and may be displayed transparently in a state before being duplicated. A second object 1533 of the first plane 1530 may be a duplicate of a second object 1543 of the second plane 1540 that is generated as being touched by the hand of the user and may be displayed with its edge in bold by the touch of the user, which may provide the user with feedback that such a touch gesture has been recognized. A third object 1535 of the first plane 1530 may be a previous duplicate of a third object 1545 of the second plane 1540.

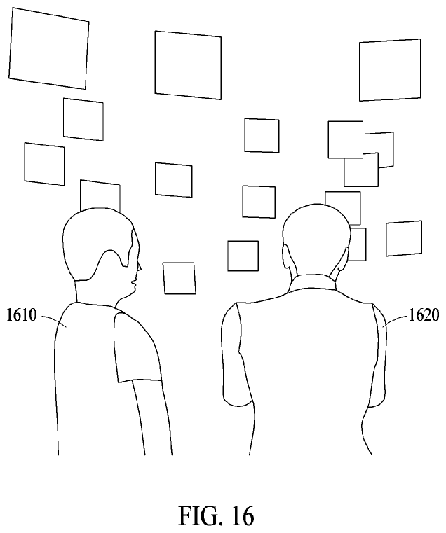

FIG. 16 is a diagram illustrating motions related to multiple users according to an embodiment.

Referring to FIG. 16, an example in which a plurality of users 1610 and 1620 access a virtual space is shown. The plurality of users 1610 and 1620 may access the virtual space at the same time and arrange, move, and delete objects in the virtual space through the control methods described above. In addition, each of the plurality of users 1610 and 1620 may independently perform the control methods but may perform the control methods together according to embodiments. For example, the manual plane generation motion and the size adjustment motion described above with reference to FIG. 6 requires both hands, but each of the plurality of users 1610 and 1620 may perform the manual plane generation motion and the size adjustment motion using one hand of each of the plurality of users 1610 and 1620, respectively. In this example, the plurality of users 1610 and 1620 may hold one plane together and perform control, and they may further perform control on one object together.

The plurality of users 1610 and 1620 may derive and organize ideas using memo objects in a virtual space free from physical limitations. Although two users are shown in FIG. 16, this is provided merely as an example for the convenience of description, and the number of users accessing the virtual space is not limited to the foregoing example.

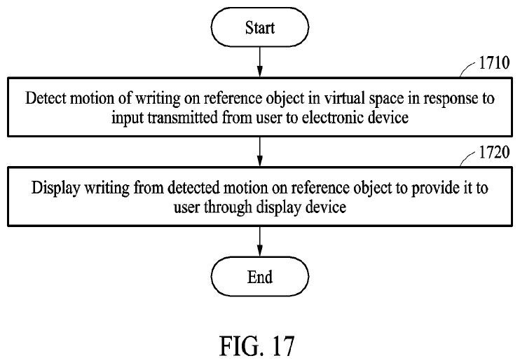

FIG. 17 is a flowchart illustrating an operating method of an electronic system according to an embodiment.

In operation 1710, an electronic system may detect a writing motion of writing on a reference object present in a virtual space according to an input transmitted from a user to the electronic device. In operation 1720, in response to the reference object being included in a scene of the virtual space corresponding to a viewpoint of the user, the electronic system may display handwriting obtained from the detected writing motion on the reference object and provide the displayed handwriting to the user through the display device. In the virtual space, the reference object may be disposed on a surface of the electronic device, at least one of both hands of the user may be tracked and displayed in the virtual space, and one or more objects present in the virtual space may be controlled by the hand being tracked.

In addition, the electronic system may determine the scene in the virtual space scene corresponding to the viewpoint of the user and provide the determined scene to the user, receive control for the objects arranged in the virtual space by tracking the hand of the user, and visually provide the user with a process of controlling the objects by the hand being tracked. The scene in the virtual space may display the object included in the scene among the one or more objects arranged in the virtual space together with the handwriting written on the object.

To the operations described above with reference to FIG. 17, what has been described above with reference to FIGS. 1 through 16 may be applicable, and thus a more detailed description thereof is omitted here.

The example embodiments described herein may be implemented using hardware components, software components and/or combinations thereof. A processing device may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as, parallel processors.

The software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

1. An electronic system comprising:
an electronic device configured to detect a writing motion of writing on a reference object in a virtual space according to an input from a user; and
a display device configured to display a scene in the virtual space corresponding to a viewpoint of the user and provide the displayed scene to the user, and in response to the reference object being included in the scene, display handwriting obtained from the writing motion on the reference object based on information transmitted from the electronic device,
wherein, in the virtual space, the reference object is arranged on a surface of the electronic device, and
at least one of both bands of the user is tracked to be displayed in the virtual space, and one or more objects present in the virtual space are controlled by the tracked hand of the user.

2. The electronic system of claim 1, wherein each of the one or more objects present in the virtual space is controlled by the tracked hand of the user while the handwriting is being maintained.

3. The electronic system of claim 1, wherein, when the user performs, with the tracked hand, a motion of holding a target object among the one or more objects arranged in the virtual space, moving the target object, and then releasing the target object, the target object is moved in the virtual space according to the motion of moving and is arranged at a position in the virtual space corresponding to a position at which the motion of releasing is performed.

4. The electronic system of claim 1, wherein, when the user performs, with the tracked hand, a motion of crumpling a target object among the one or more objects arranged in the virtual space and then releasing the target object, the target object is crumpled in the virtual space according to the motion of crumpling and falls onto a floor in the virtual space according to the motion of releasing.

5. The electronic system of claim 1, wherein, when the user performs, with the tracked hand, a motion of unfolding a crumpled target object in the virtual space, the target object is unfolded in the virtual space according to the motion of unfolding, and handwriting written on the target object is displayed.

6. The electronic system of claim 1, wherein, when the user performs, with both tracked hands, a motion of clenching a first within a predetermined distance, or a motion of clenching a first within the predetermined distance and then moving the hands away from each other, a plane of a size corresponding to a distance between the hands is generated in the virtual space, and
when the user performs, with both tracked hands, a motion of adjusting the distance between the hands while maintaining the tracked hands fisted, the size of the plane generated in the virtual space is controlled according to the adjusted distance between the hands.

7. The electronic system of claim 1, wherein, when the user performs, with both tracked hands or one tracked hand, a motion of holding and moving a plane in the virtual space and then releasing the plane, the plane is moved in the virtual space according to the motion of moving and is then arranged at a position in the virtual space at which the motion of releasing is performed.

8. The electronic system of claim 1, wherein, when the user performs, with both tracked hands, a motion of holding a plane in the virtual space and reducing a distance between the hands to a predetermined distance or less,
in the absence of an object attached to the plane, the plane is deleted from the virtual space; and
in the presence of an object attached to the plane, the plane is not reduced to less than a size of an edge of the object attached to the plane.

9. The electronic system of claim 1, wherein, when the user performs a pinch gesture with one of both tracked hands and then performs a pinch gesture with the other hand, a non-directional link that connects the hands is generated in the virtual space.

10. The electronic system of claim 1, wherein, when the user performs a pinch gesture with one of both tracked hands and then performs a pinch gesture while moving the other hand in one direction, a directional link that connects the hands in the virtual space and has an arrow displayed in a portion corresponding to the other hand is generated.

11. The electronic system of claim 9- or 10, wherein, when the user releases the pinch gesture within a predetermined distance, for two target objects arranged in the virtual space, with both tracked hands in a state in which the non-directional link or the directional link is generated, the non-directional link or the directional link connects the two target objects in the virtual space.

12. The electronic system of claim 1, wherein, when the user performs, with the tracked hand, a motion of holding and pulling a link that connects two target objects arranged in the virtual space by a predetermined distance or greater, the link is deleted from the virtual space.

13. The electronic system of claim 1, wherein, when the user performs, with the tracked hand, a motion of holding a tag object in the virtual space, moving the tag object to be within a predetermined distance to a link that connects two target objects, and then releasing the tag object, the tag object is arranged at a predetermined angle in the link according to the motion of releasing.

14. The electronic system of claim 1, wherein, when the user performs, with the tracked hand, a motion of holding a target object among a plurality of objects arranged in the virtual space and moving the target object to be within a predetermined distance to another object to align the target object and the other object at a predetermined angle, and then releasing the target object, a plane to which the target object and the other object are to be attached is generated in the virtual space.

15. The electronic system of claim 1, wherein, when the user performs, with the tracked hand, a motion of holding a target object in the virtual space and moving the target object to be within a predetermined distance on a plane, a feed forward corresponding to the target object is displayed on the plane in the virtual space, and
when the user performs a motion of releasing the target object, the target object is attached to a position of the feed forward displayed on the plane in the virtual space.

16. The electronic system of claim 1, wherein, when the user performs, with the tracked hand, a motion of moving a target object in a plane arranged in the virtual space on the plane, the target object is moved according to the motion performed by the user on the plane in the virtual space.

17. The electronic system of claim 1, wherein, when the user performs a motion of touching a target object in a plane arranged in the virtual space with one of both tracked hands and moving another object with the other hand while the one hand is touching the target object such that the other object is aligned with the target object on the plane, the other object is aligned with the target object on the plane in the virtual space.

18. The electronic system of claim 1, wherein, when the user performs, with the tracked hand, a motion of holding a first plane in the virtual space and allowing the first plane to penetrate through a second plane to which one or more objects are attached in a predetermined direction, an object in an area in the second plane through which the first plane penetrates is moved from the second plane to the first plane according to the motion performed by the user.

19. The electronic system of claim 1, wherein, when the user performs, with the tracked hand, a motion of holding a first plane in the virtual space and bringing the first plane to be within a predetermined distance to a second plane to which one or more objects are attached, an object in an area in the second plane corresponding to the first plane is projected onto the first plane in the virtual space, and
when the user performs a motion of touching the object projected on the first plane, the object corresponding to the motion of touching is duplicated on the first plane in the virtual space.

20. The electronic system of claim 1, wherein at least one of the objects present in the virtual space is controlled by one or more of a plurality of users accessing the virtual space.

21. An electronic system comprising:
a display device configured to display a scene of a virtual space corresponding to a viewpoint of a user and provide the displayed scene to the user, and display an object included in the scene among objects arranged in the virtual space together with handwriting written on the object; and
a sensor configured to track at least one of both hands of the user,
wherein at least one of both hands of the user is tracked by the sensor and is displayed in the virtual space, and one or more objects present in the virtual space are controlled by the tracked hand of the user.

22. An operating method of an electronic system, comprising:
detecting a writing motion of writing on a reference object present in a virtual space according to an input transmitted from a user to an electronic device; and
in response to the reference object being included in a scene of the virtual space corresponding to a viewpoint of the user, displaying handwriting obtained from the detected writing motion on the reference object and providing the handwriting to the user through a display device,
wherein, in the virtual space, the reference object is arranged on a surface of the electronic device, and
at least one of both hands of the user is tracked and displayed in the virtual space, and one or more objects present in the virtual space are controlled by the tracked hand of the user.
